(19) United States
(12) Patent Application Publication
(10) Pub. No.: US 2018/0067481 A1
(43) Pub. Date: Mar. 8, 2018

(54) MAIL RETRIEVAL SYSTEM

(71) Applicant: Rusty Wallace, Crosbyton, TX (US)

(72) Inventor: Rusty Wallace, Crosbyton, TX (US)

(21) Appl. No.: 15/255,933

(22) Filed: Sep. 2, 2016

(51) Int. Cl. G05D 1/00; B25J 5/00; A47G 29/122

(52) U.S. Cl. CPC G05D 1/0016; A47G 29/1225; B25J 5/007

(57) ABSTRACT

The present application includes a system and method for moving mail from the curbside to the building doorstep. The mail retrieval system is comprised of a control unit, a guidance device and a mail transport. The control unit alerts the user to the presence of mail at the curbside and allows the user to initiate mail retrieval. The mail transport follows the guidance device to the building doorstep for retrieval by the user.

### BACKGROUND

### 1. Field of the Invention

The present application relates generally to a depository device and more particularly to a depository device that transports mail from the curbside to the doorstep.

### 2. Description of Related Art

The United States Postal Service's largest 2013 annual fixed cost was $30 billion for the delivery of mail. The Office of Inspector General estimated that $4.5 billion could be saved each year by ending doorstep delivery, in which the mail is delivered to a mailbox attached to the building or inserted through a slot in the door. Such cost reduction exerts pressure on the postal service to mandate curbside delivery.

While curbside delivery saves the US Postal Service money, it can pose a serious problem for those people who are disabled or cannot retrieve their mail because of reduced ability or risk of injury. According to the US Census Bureau 2011 statistics, the number of people who had ambulatory difficulty was 8 million. Requests for doorstep delivery can be submitted to the local postmaster based on medical condition. However, it is still up to the postmaster to approve the request.

If the request for doorstep delivery is denied, then other options may include: 1) A neighbor or family member brings the mail to the door, 2) Mail delivered at a postal center, and hire someone to pick up the mail and deliver it to the door.

It is desired that a system be developed to facilitate moving mail from the curbside mailbox to the building doorstep, without the building occupant having to go to the curb. Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a mail retrieval system according to an embodiment of the present application.

FIG. 2 is a view of a guidance device in the mail retrieval system of FIG. 1.

FIG. 3 is a side view of an alternative embodiment of the mail retrieval system of FIG. 1, using a chain loop to guide the mail transport.

FIG. 4 is a side view of an alternative embodiment of the mail retrieval system of FIG. 1, using a cable to guide the mail transport.

FIG. 5 is a side view of an alternative embodiment of the mail retrieval system of FIG. 1, using a guide wire to guide the mail transport.

FIG. 6 is a side view of an alternative embodiment of the mail retrieval system of FIG. 1, using a remote control to guide the mail transport.

FIG. 7 is a side view of an alternative embodiment of the mail retrieval system of FIG. 1, using automatic guidance to guide the mail transport.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with conventional curbside mailboxes. The mail retrieval system receives mail at the curbside and selectively transports the mail to the building doorstep. The advantages of the system includes: 1) doorstep delivery for those who cannot go outside further than the doorstep, 2) the reduction of injuries caused by walking on steps, sloped or uneven ground, and 3) reduced delivery cost to the US Postal Service. These and other unique features of the system and method are discussed below and illustrated in the accompanying drawings.

The system and method will be understood, both as to its structure and operation, from the accompanying drawings, taken in conjunction with the accompanying description. Several embodiments of the assembly are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The mail retrieval system includes one or more electronic devices in communication with each other that provide the building occupant with mail delivery information and allows the occupant to initiate transport of the depository to the doorstep. The system includes programmable software to permit functional interfaces for the building occupants. The programmable software is processed and executed through the one or more electronic devices. The method includes a series of steps interacting with a control unit, a guidance device and a mail transport to retrieve the mail. Communications messages referred to herein pertain to the general meaning of the message and not necessarily the literal representation of the message in an encoding scheme, such as ASCII, for example.

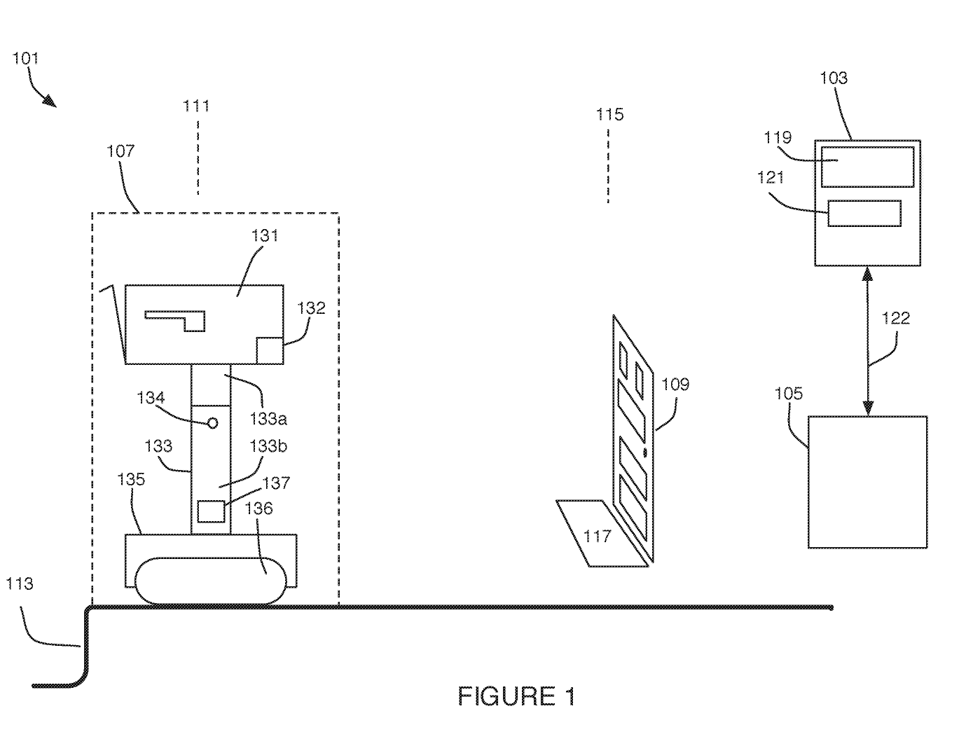

Referring now to the drawings wherein like reference characters identify corresponding or similar elements in form and function throughout the several views. FIG. 1 illustrates a mail retrieval system 101 of the present application. An embodiment of the present application comprises a control unit 103, a guidance device 105, and a mail transport 107. The control unit 103 is located in a user's building and is in communication with guidance device 105, and mail transport 107. Guidance device 105 controls the selective movement of mail transport 107 from a mail delivery location 111 to a destination 115. The mail transport 107 receives mail at mail delivery location 111 and selectively moves the mail transport to destination 115. Selective movement of mail transport 107 toward destination 115 may be chosen out of many possibilities. As an example, movement of mail transport 107 can be initiated automatically at a set time each day, or just after mail is delivered. A user may also initiate movement of mail transport 107 manually.

An example of mail delivery location 111 is near a road curbside 113. An example of destination 115 is a building doorstep 117 in front of door 109. Other mail delivery locations 111 and destinations 115 are possible, including either or both locations being inside a building.

Control unit 103 is an electronic module comprising a user interface 119 and an input member 121. The control unit 103 is in communication with mail transport 107 and guidance device 105. The user interacts with user interface 119 and input member 121 to determine when movement of mail is initiated. Control unit 103 may be a mounted device within a home or structure wherein the user may access. It may include one or more remotes to permit operation within various locations within the structure. The remotes would operate via wireless communication methods with the main unit 103. Additionally it is conceived that unit 103 may be a portable electronic device such as a smart phone, electronic tablet, computer, and the like. This allows full mobility of the user to operate system 101 from anywhere a signal is accessible. Unit 103 may include operable downloadable software applications to permit operation. This is seen especially when unit 103 is a portable electronic device as described.

One possible example of user interface 119 is an indicator light and an example of input member 121 is a momentary button switch. After mail is delivered the mail transport 107 communicates the presence of mail to control unit 103 causing the indicator light to illuminate. The user notices the indicator light and pushes the momentary button switch causing mail transport 107 to begin moving toward the destination 115.

Another possible example of user interface 119 is a touch sensitive liquid crystal display (LCD) with microprocessor controller and an example of input member 121 is a menu on the LCD display. The user can use the menu in conjunction with the touchscreen to select automatic or manual initiation of mail transport 107 travel.

Guidance device 105 guides mail transport 107 from mail delivery location 111 to destination 115. Guidance device 105 is in communication with control unit 103 through a link 122. Link 122 may be a wired link, with both signal and power or it may be a signal only link including wireless.

The mail transport 107 is comprised of a depository 131, a mail sensor 132, a connecting post 133, and a transport base 135 and at least one rolling element 136. The transport base 135 is in communication with the control unit 103. Connecting post 133 is coupled to the depository 131 and to the transport base 135 such that depository 131 is at a height appropriate for mail delivery and retrieval. One possible example of connecting post 133 is post 133 comprising of two or more telescoping members 133a and 133b, that can be fixed together by fastener 134, allowing depository 131 to be adjustable in height. Rolling element 136 is coupled to transport base 135 and is configured to allow mail transport 107 to move on terrain between mail delivery location 111 and destination 115. Factors determining the number and nature of rolling elements may depend on terrain and climate. An example of rolling element 136 is a continuous track. Another example of rolling element 136 is four wheels with deep tread.

The mail sensor 132 is coupled to depository 131 and is in communication with transport base 135. Mail sensor 132 is configured to detect the presence of mail, usually by the weight of depository 131 contents. Other mail detection methods such a light source being occluded by mail for example, can be used instead. Upon detection of mail, mail sensor 132 sends a “mail present” message to the control unit 103. It is also conceived a camera may be included within depository 131 wherein visual/sound data is transmitted to interface 119 for display to a user. In this way, the user may check interface 119 and visually see what is within depository 131.

Communication between the control unit 103 and the mail transport 107 are not limited to “retrieve” and “return” messages. For example, in an alternative embodiment, messages may control direction and speed of travel of the mail transport. In another alternative embodiment, audio and video may be sent along with control messages. Implementation of Internet Protocol (IP) between control unit 103 and mail transport 107 is just one of many methods that would allow a computer or phone to function as the control unit 103.

Another alternative embodiment is that shown in FIG. 1 with connecting post 133 being adjustable in height using one or more electric post motors 137 coupled to two or more telescoping members 136a, 136b. In this manner a height of the depository appropriate for mail delivery location 111 and destination 115 can be modified as necessary. The height of depository 131 can also be minimized when mail transport 107 is in transit to enhance stability of mail transport 107.

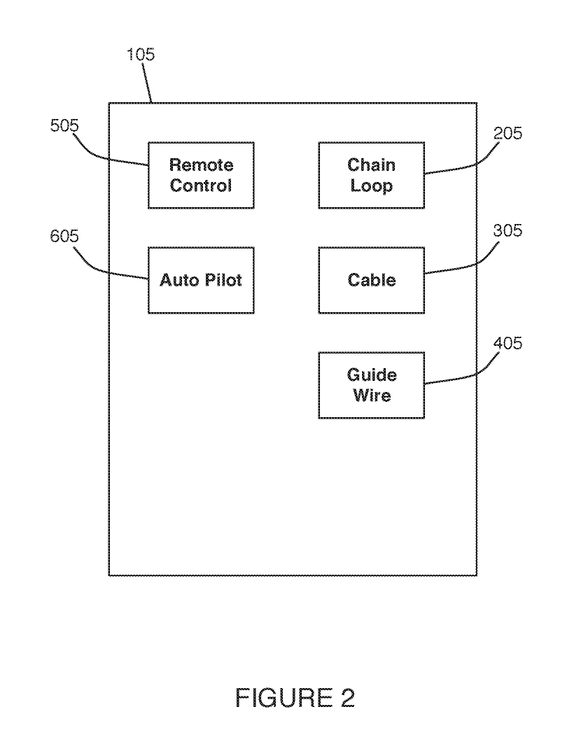

Referring now also to FIG. 2 in the drawings, multiple exemplary embodiments of guidance device 105 are shown, including but not limited to a chain loop guidance device 205, a cable guidance device 305, a guide wire guidance device 405, a remote control guidance device 505 and an automatic guidance device 605. These embodiments are not meant to be mutually exclusive and elements of one embodiment may be used in other embodiments.

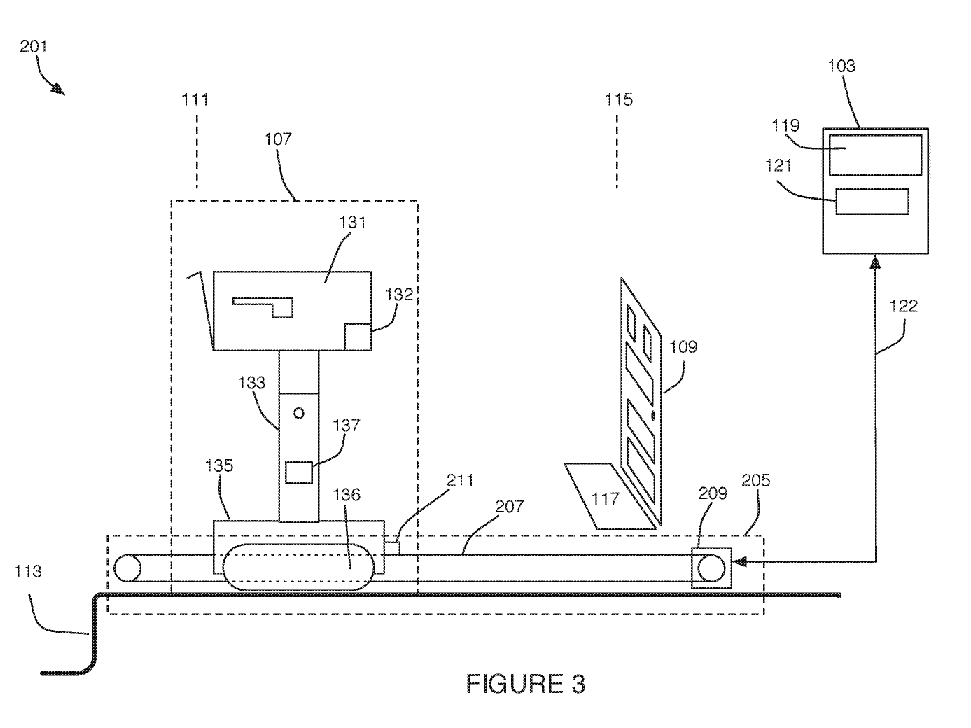

Referring now to FIG. 3 in the drawings, a side view of an alternative embodiment of system 101 is illustrated. System 201 is similar to system 101 in form and function except as noted herein. Guidance device 105 in FIG. 1 is shown in more detail as a chain loop guidance device 205 in FIG. 3. Chain loop guidance device 205 includes a chain 207, a motor 209, and a coupler 211. Chain 207 is run along the path that mail transport 107 is to travel between mail delivery location 111 and destination 115. Coupler 211 couples chain 207 with mail transport 107 allowing the chain to move mail transport 107. Motor 209 couples to the chain 207 providing motive force to move mail transport 107.

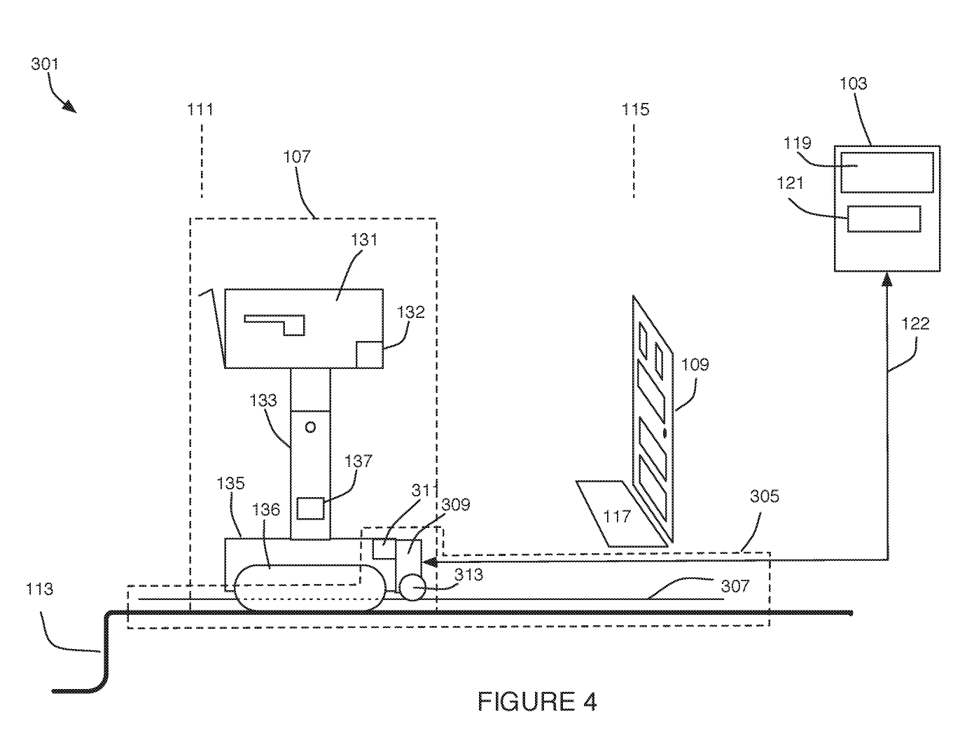

Referring now to FIG. 4 in the drawings, a side view of an alternative embodiment of system 101 is shown. System 301 is similar to system 101 in form and function except as noted herein. Guidance device 105 in FIG. 1 is shown in more detail as a cable guidance device 305 in FIG. 4. Cable guidance device 305 includes a cable 307, a motor 309, a battery 311 and a coupler 313. Cable 307 is placed between mail delivery location 111 and destination 115 along the desired path of travel of the mail transport 107. Coupler 313, battery 311 and motor 309 are coupled to mail transport 107. Battery 311 is coupled with motor 309, selectively providing electrical power to motor 309. Motor 309 is coupled to coupler 313, providing motive force to move mail transport 107 along cable 307.

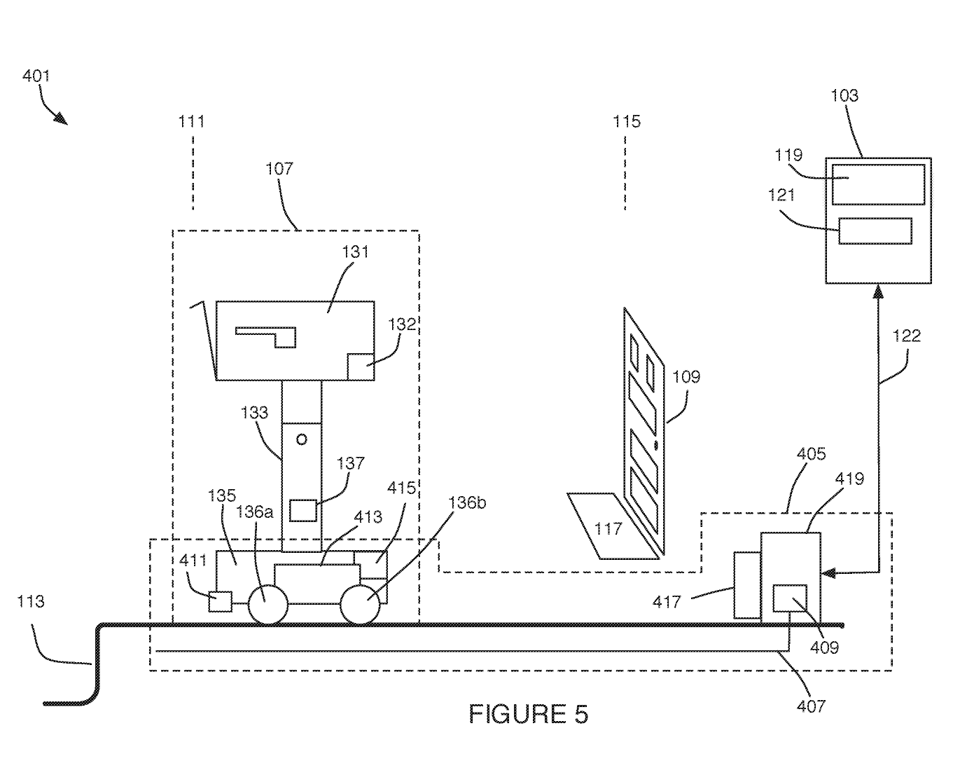

Referring now to FIG. 5 in the drawings, a side view of an alternative embodiment of system 101 is illustrated. System 401 is similar to system 101 in form and function except as noted herein. Guidance device 105 in FIG. 1 is shown in more detail as a guide wire guidance device 405 in FIG. 5. Guide wire guidance device 405 includes a guide wire 407, a signal generator 409, a guidance sensor 411, a control module 413, and a battery 415. Guide wire 407 is placed along the desired path of travel of mail transport 107 between mail delivery location 111 and destination 115. Guide wire 407 may be placed at or below the surface of the ground. Signal generator 409 is connected to guide wire 407 and generates a guide signal. Guidance sensor 411 receives the guide signal emitted by guide wire 407. Control module 413 is coupled to rolling elements 136a and 136b, which in this embodiment are wheels and configured to move and guide mail transport 107 using one or more electric motors, which are part of the control module. Guidance sensor 411 is in communication with control module 413, which together are configured to minimize the distance between the mail transport 107 and the guide wire 407. Battery 415 is coupled to control module 413 to provide electricity to control module 413.

Guide wire guidance device 405 may, for example, also include a dock 417 and a battery charger 419 near destination 115. Mail transport 107 can removably couple with dock 417 near destination 115, at least partially charge battery 415 and selectively return to mail delivery location 111. The selective return of mail transport 107 may be chosen by the user using control unit 103.

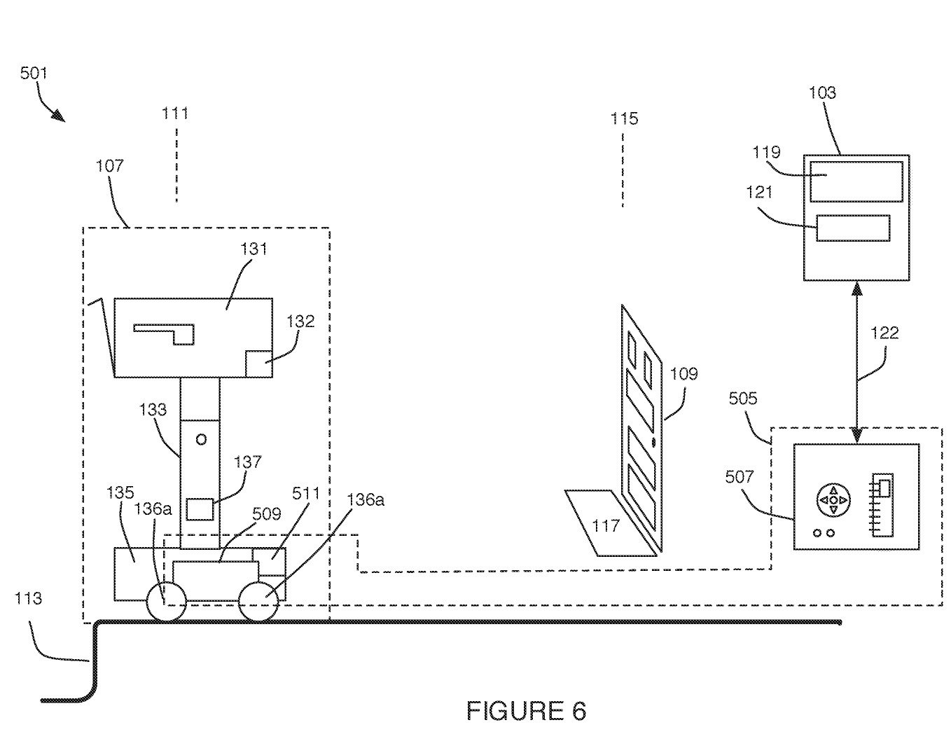

Referring now to FIG. 6 in the drawings, a side view of an alternative embodiment of system 101 is illustrated. System 501 is similar to system 101 shown in FIG. 1, except as noted herein. Guidance device 105 in FIG. 1 is shown in more detail as a remote control guidance device 505 in FIG. 6. Remote control guidance device 505 includes a remote control 507, a control module 509, and a battery 511. Remote control 507 allows the user to selectively guide mail transport 107. Remote control 507 may, for example, be in direct communication with mail transport 107 to perform its guidance function. Remote control 507 may also use control unit 103 for communication with mail transport 107. In another example, remote control 507 may be integrated with control unit 103, using user interface 119 and input member 121 to guide mail transport 107. Cameras on mail transport 107 may display imagery on control unit 103 or any other interface (i.e. control 507) to give the user visual indication of the direction of mail transport 107 as it is being remotely guided.

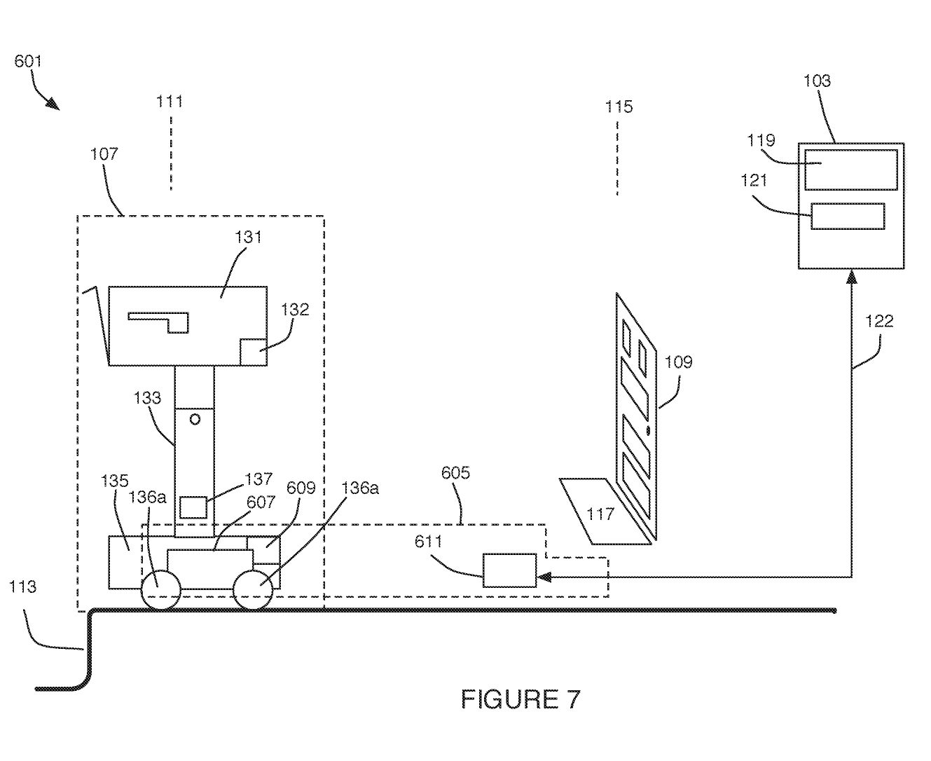

Referring now to FIG. 7 in the drawings, a side view of an alternative embodiment of system 101 is illustrated. System 601 is similar to system 101 in form and function except as noted herein. Guidance device 105 in FIG. 1 is shown in more detail as an automatic guidance device 605 in FIG. 7. Automatic guidance device 605 includes a controller module 607 and a battery 609. Controller module 607 and battery 609 are both coupled to mail transport 107. Battery 609 is connected to controller module 607. Controller module 607 is coupled to rolling elements 136a and 136b and configured to control speed and direction of mail transport 107. Examples of roller elements 136a and 136b are wheels. Controller module 607 is configured to determine the location of mail transport 107. An example of location determination is control module 607 using of the global positioning system (GPS). Another example is control module 607 including a camera and software for waypoint recognition. The automatic guidance device 605 may also include one or more location help devices 611. An example of location help device 611 may be a visual indicator recognizable to control module 607. Another example of a location help device is a signal transmitter. The signal strength or difference between arrival time of multiple signals may be used by control module 607 to determine the location of mail transport 107.

A plurality of help devices 611 may be disposed along the path of mail transport 107 or outside the path of mail transport 107, or some combination thereof.

The current application has many advantages over the prior art including at least the following: (1) doorstep delivery for those who cannot go outside further than the doorstep and (2) the reduction of injuries caused by walking on steps, sloped or uneven ground.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A system for moving mail from a mail delivery location to a destination, comprising:
a control unit comprising a user interface and an input member; the control unit configured to regulate the movement of the mail, the control unit further configured to selectively initiate the movement of the mail to the destination;
a mail transport in communication with the control unit, the mail transport configured to move mail from the mail delivery location to the destination; and
a guidance device in communication with the control unit, the guidance device configured to guide the mail transport between the mail delivery location and the destination;
wherein the mail can be retrieved at the destination by a user.

2. The system of claim 1, wherein the mail transport is comprised of:
a depository configured to receive mail and retrieve mail therefrom;
a connecting post coupled to the depository, configured to set the height of the depository appropriate for receiving mail and retrieving mail therefrom; and
a transport base, coupled to the connecting post, capable of stabilizing the mail transport; the transport base being in communication with the control unit.

3. The system of claim 2, further comprising:
a mail sensor coupled to the depository, the mail sensor configured to detect the presence of mail and communicates the mail presence to the control unit.

4. The system of claim 2, further comprising:
at least one rolling element coupled to the transport base configured to allow the mail transport to move.

5. The system of claim 2, wherein the connecting post comprises two or more telescoping members configured to adjust the height of the depository.

4. The system of claim 5, wherein the connecting post further comprises at least one post motor coupled to the telescoping members such that the post motors are configured to regulate the height of the depository.

5. The system of claim 1, wherein the guidance device includes:
a chain loop coupled to the transport base configured to guide the mail transport between the mail delivery location and the destination; and
a motor coupled to the chain loop, the motor in communication with the control unit, configured to regulate movement of the mail transport.

6. The system of claim 1, wherein the guidance device includes:
a cable coupled to the transport base configured to guide the mail transport between the mail delivery location and the destination; and
a motor coupled to the cable, the motor in communication with the control unit, configured to regulate movement of the mail transport.

7. The system of claim 1, in which the guidance device includes:
a guide wire cable of emitting a signal;
a guide signal generator in communication with the control unit; and
a guide receiver coupled to the mail transport configured to regulate movement of the mail transport.

8. The system of claim 1, in which the guidance device includes:
a remote control guidance device; and
a control module in communication with the remote control guidance device; the control module configured to regulate movement of the mail transport.

9. The system of claim 1, in which the guidance device includes:
a control module coupled to the mail transport; the control module being configured to locate the mail transport and further configured to regulate movement of the mail transport.

10. A method of moving mail from a mail delivery location to a destination, comprising the steps of:
operating at least one motor to selectively move a depository;
translating the depository between a first location and a second location; and
retrieving mail from the depository.

11. The method of claim 10, further comprising the steps of:
determining mail is present in the depository through one or more sensors; and
communication the presence of the mail with a control unit.

12. The method of claim 11, further comprising:
notifying a user that mail is present using an indicator on the control unit.

13. The method of claim 10, further comprising the step of guiding the depository between a first location and a second location with a guidance device.

14. The method of claim 13, wherein the guidance device includes a chain loop.

15. The method of claim 13, wherein the guidance device includes a cable.

16. The method of claim 13, further comprising the step of manually guiding the depository with a remote control operated by a user.

17. The method of claim 13, further comprising the step of automatically operating the depository between the first location and the second location.
